(19) United States
(12) Patent Application Publication
(10) Pub. No.: US 2023/0400147 A1
(43) Pub. Date: Dec. 14, 2023

(54) ADJUSTABLE MOUNTING ASSEMBLIES

(71) Applicant: Rite-Hite Holding Corporation, Milwaukee, WI (US)

(72) Inventors: Blaine Schmidt, Dubuque, IA (US); Nicholas L. Kaufmann, Sherrill, IA (US); Kevin Gebke, Dubuque, IA (US); Casey Nemmers, Bellevue, IA (US)

(21) Appl. No.: 18/331,755

(22) Filed: Jun. 8, 2023

Related U.S. Application Data
(60) Provisional application No. 63/350,280, filed on Jun. 8, 2022.

(51) Int. Cl. F16M 13/02; F16M 11/10; F16M 11/08; F16M 11/04

(52) U.S. Cl. CPC F16M 13/022; F16M 13/02; F16M 11/10; F16M 11/08; F16M 11/045

(57) ABSTRACT

Adjustable mounting assemblies are disclosed. An example apparatus includes an arm to extend along a longitudinal axis between a first end and a second end, the arm including an elongate slot to enable attachment of a fan to the arm at selectively different positions along the longitudinal axis, a first joint plate coupled to the first end of the arm, and a second joint plate coupled to the second end of the arm, the first and second joint plates structured to enable attachment to an external support structure.

### RELATED APPLICATIONS

This patent claims priority to U.S. Provisional Patent Application No. 63/350,280, which was filed on Jun. 8, 2022. U.S. Provisional Patent Application No. 63/350,280 is incorporated herein by reference in its entirety.

### FIELD OF THE DISCLOSURE

This disclosure relates generally to fans and, more particularly, to adjustable mounting assemblies.

### BACKGROUND

Grow facilities often include racks and shelving to arrange plants for indoor cultivation. These racks may include fans and/or ductwork to provide air to the plants.

### BRIEF DESCRIPTION OF THE DRAWINGS

FIGS. 1-3 illustrate storage structures at a grow facility.

FIG. 4 is an example mounting assembly constructed in accordance with teachings disclosed herein.

FIG. 5 is another example mounting assembly constructed in accordance with teachings disclosed herein.

FIG. 6 is another example mounting assembly constructed in accordance with teachings disclosed herein.

FIG. 7 is yet another example mounting assembly constructed in accordance with teachings disclosed herein.

FIG. 8 is yet another example mounting assembly constructed in accordance with teachings disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

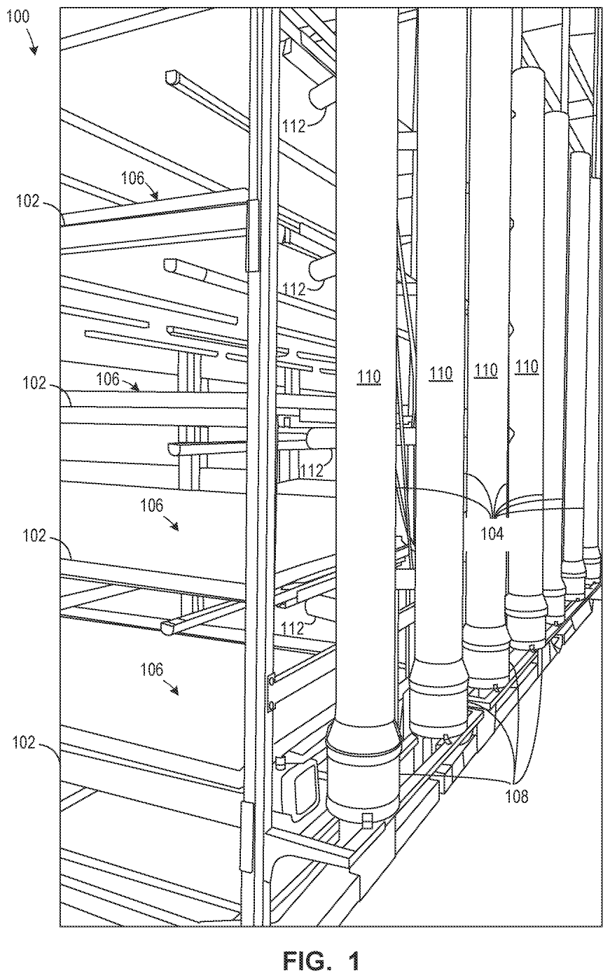

Grow facilities are frequently used for indoor planting. These facilities mitigate the risks of extreme weather for plant cultivation while optimizing yield, quality, and consistency of the plants. Often included in industrial environments, grow facilities can be designed to optimally store and grow plants. For example, electrical and/or mechanical systems (e.g., water supply, oxygen supply, temperature control, light source, etc.) can be implemented into the design of such facilities to meet the requirements for plant growth. In an industrial setting, plants can be arranged on multiple shelves of a metal structure, for example. These structures can integrate (e.g., orient, position, arrange, etc.) the electrical and/or mechanical systems to allow for plant growth and preservation. Fan assemblies can be included in such designs to distribute air and control temperature throughout these structures, as shown and described in connection with FIGS. 1-3. Examples disclosed herein are described in the context of a grow facility. However, any of the examples disclosed herein can be included in any other type of application (e.g., manufacturing, production line, storage facility, technical laboratory, etc.).

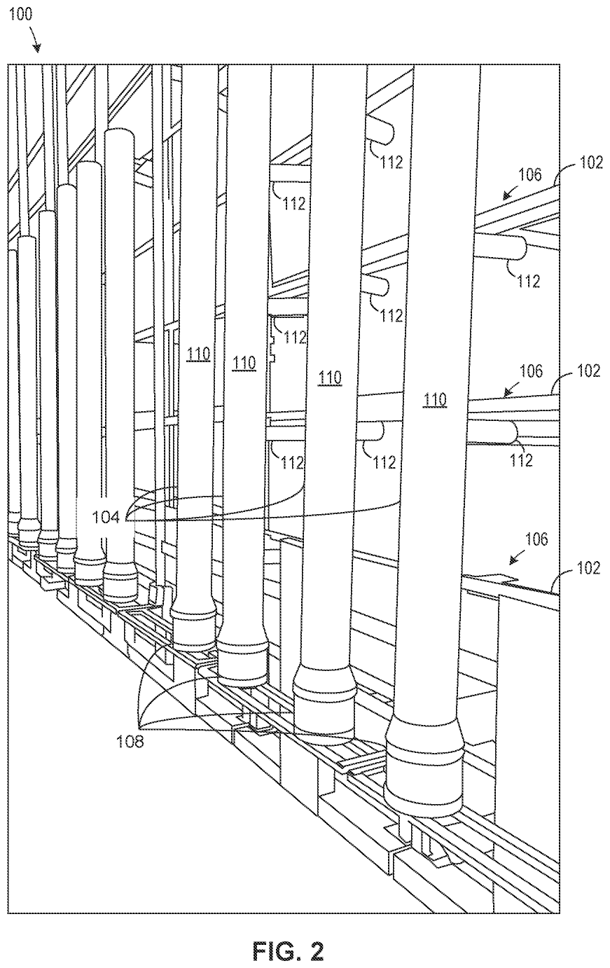

In particular, FIG. 1 is a partial perspective view of an example grow structure 100 for use in a grow facility. FIG. 2 is another partial perspective view of the example grow structure 100. As shown in FIGS. 1 and 2, the grow structure 100 includes multiple example shelves 102 and example fan assemblies 104. Each of the multiple shelves 102 include corresponding example plant beds 106. The fan assemblies 104 are positioned along a vertical edge of the structure 100. The fan assemblies 104 include an example base 108, an example vertical duct 110, and example branch ducts 112. Each of the bases 108 includes a fan for pushing (e.g., distributing, blowing, etc.) air through the vertical duct 110. In FIGS. 1 and 2, the air travels in a direction along the vertical edge of the structure 100 and is distributed to each of the shelves 102 (and associated plat bed 106) via the branch ducts 112.

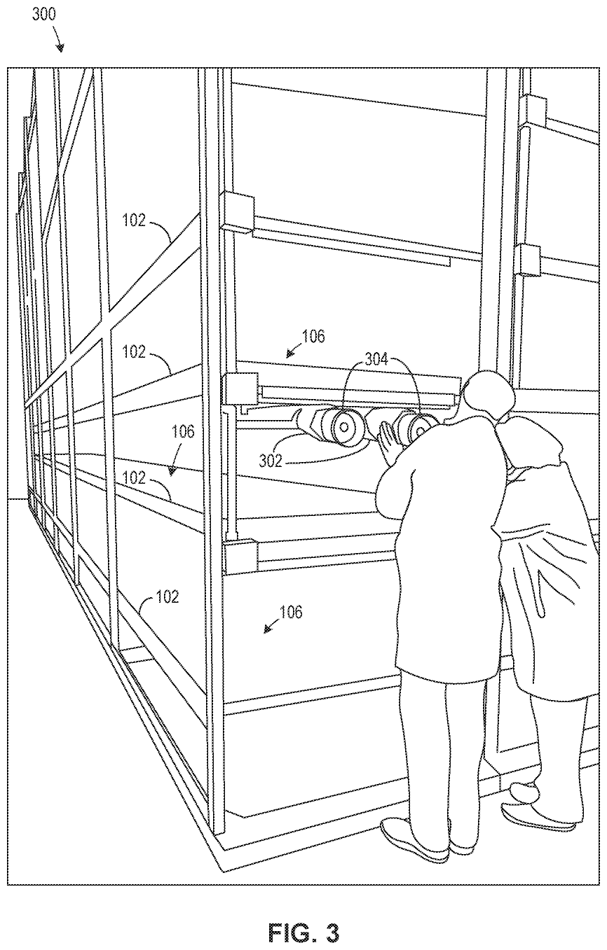

FIG. 3 is a perspective view of another example grow structure 300 for use in a grow facility. The grow structure 300 of FIG. 3 is similar to the grow structure 100 of FIGS. 1 and 2. However, unlike in FIGS. 1 and 2 that include the fan assemblies 104 that deliver air via the ducts 110, 112, FIG. 3 illustrates example fan assemblies 302 positioned on a horizontal plane of the structure 300 to force air towards a particular one of the shelves 102 (and associated plant bed 106). More particularly, in FIG. 3, the fan assemblies 302 are connected to an edge of the structure 300 and include fans 304 that are oriented to push air horizontally across the shelves 102. The fan assemblies 104, 302 in the structures 100, 300 of FIGS. 1-3 have relatively rigid structures with fixed positions (e.g., orientations) for the ducts, fans, and/or other components. The fixed placements of fan assemblies can limit (e.g., restrict, impede, etc.) oxygen supply to the plant beds 106. Proper positioning of air flow relative to the plant beds 106 can provide a preferred growth environment and can improve (e.g., optimize) air supply and temperature for the plants. The fixed fan assemblies 104, 302 in FIGS. 1-3 limit adjustability and adaptability in the operations of grow facilities associated with the structures 100, 300.

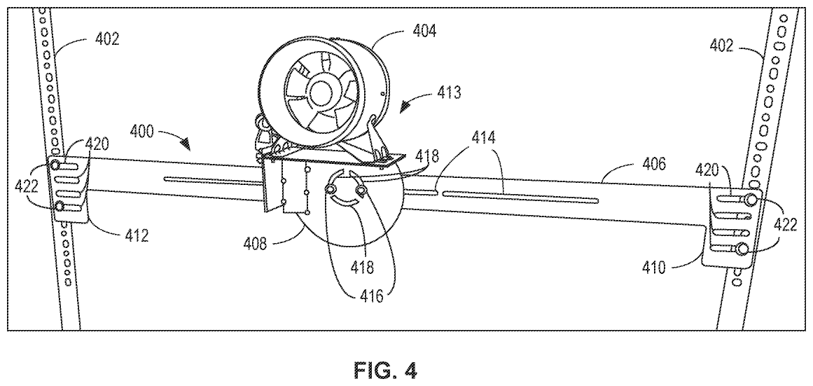

FIGS. 4-8 illustrate example mounting assemblies 400, 500, 600, 700, 800 constructed in accordance with teachings of this disclosure that can support one or more fans thereon. Turning to FIG. 4, a first example mounting assembly 400 is shown extending between two portions of an example frame (e.g., external support structure, external frame, etc.) 402 and supporting an example fan 404 therebetween. In the example of FIG. 4, the mounting assembly 400 is detachably coupled (e.g., bolted) to the frame 402. In some examples, the frame 402 corresponds to a rack in the grow structures 100, 300 of FIG. 3. However, the mounting assembly 400 can be detachably coupled to the structures 100, 300 along the vertical edge, for example. In some examples, the mounting assembly 400 can be detachably coupled to any edge of the structures 100, 300 to position the fan 404 in multiple locations relative to the structures 100, 300.

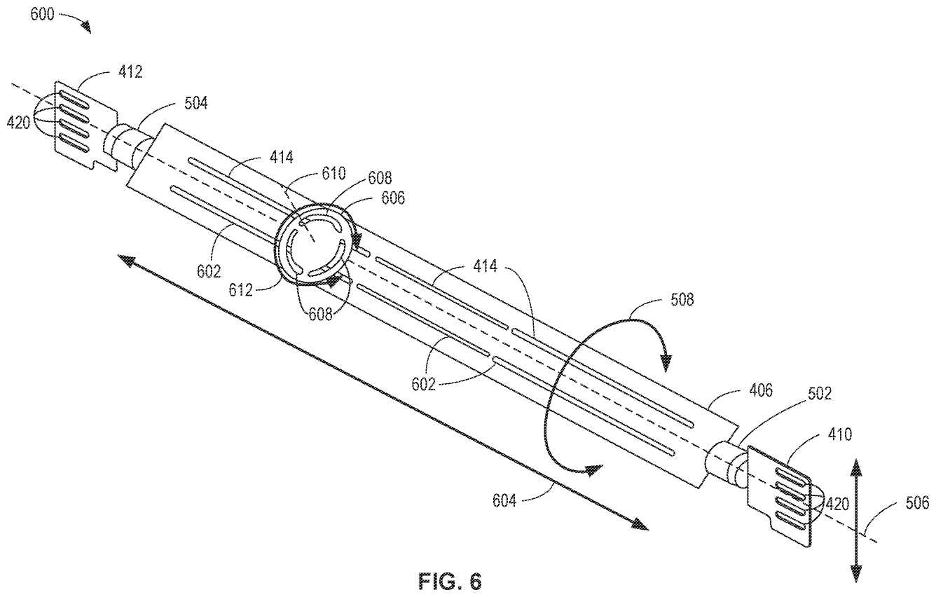

As shown in the illustrated example, the mounting assembly 400 includes an example arm 406 (e.g., elongate body), an example mounting plate 408, and example joint plates 410, 412 (e.g., mounting plates). In some examples, the joint plates 410, 412 are integral extensions of the arm 406. That is, in some examples, the joint plates or mounting plates 410, 412 are part of the arm or elongate body 406. In other examples, the joint plates 410, 412 are distinct from and rigidly affixed to the arm 406 (e.g., via one or more threaded fasteners, one or more welds, one or more press fittings, and/or one or more adhesives). In some examples, an example fan assembly 413 includes the mounting plate 408 and the fan 404. The example arm 406 extends between the plates 410, 412 and includes one or more example elongated slots 414. The example fan 404 is selectively mounted to the arm 406 via the mounting plate 408 that is connected to (e.g., positioned on, coupled to, etc.) the arm 406 via one or more example threaded fasteners (e.g., bolts) 416 extending through the slots 414. Accordingly, the example mounting plate 408 is couplable to the fan 404. In the example of FIG. 4, the mounting plate 408 is generally circular. However, the example mounting plate 408 can be any shape to achieve a desired orientation of the fan 404 with respect to the arm 406 and/or the mounting assembly 400. Additionally or alternatively, in some examples, the mounting plate 408 includes example curved slots 418 through which the fasteners 416 extend to enable the mounting plate 408 to be selectively positioned with different orientations relative to the arm 406 when attached thereto. In some examples, the mounting plate 408 is omitted and the fan 404 is mounted. The example fan 404 (or the fan assembly 413) can be positioned at any longitudinal position on the arm 406 associated with the elongated length of the slots 414. As such, the example fan 404 and/or the fan assembly 413 is movable along a longitudinal axis of the arm 406. In some examples, the mounting plate 408 can be rotatable (e.g., adjustable) about an axis, as described in further detail below in connection with FIGS. 6-8.

Further, the example joint plates 410, 412 include example slots (e.g., holes) 420 through which example fasteners 422 extend to enable the arm 406 to be mounted at different positions relative to the frame 402 when attached (e.g., coupled) thereto. For example, the joint plates 410, 412 are structured to enable attachment to the frame 402. In the example of FIG. 4, the example joint plate 410 (and first ones of the slots 420) is positioned near (e.g., proximate) a first end of the arm 406 and the joint plate 412 (and second ones of the slots 420) is positioned near a second end of the arm 406. In some examples, an example portion of the arm 406 that extends between the joint plates 410, 412 can be referred to as a central arm of the arm 406.

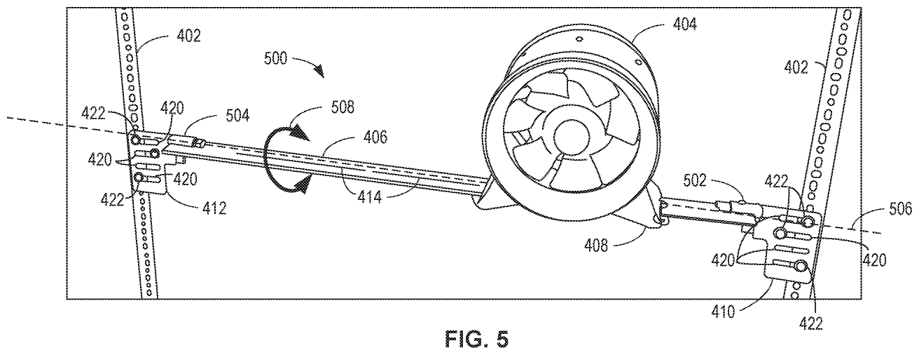

FIG. 5 illustrates another example mounting assembly 500 that is similar to the example mounting assembly 400 of FIG. 4. However, the example mounting assembly 500 includes example pivot joints 502, 504 that rotatably connect (e.g., pivotably couple, join, etc.) the arm 406 to the joint plates 410, 412. In the example of FIG. 5, the joint plates 410, 412 are detachably coupled to the frame 402, and the arm 406 is rotatable about an example axis 506. The example fan 404 is positioned at a first rotational position about the axis 506. However, the example fan 404 can be positioned at any rotational position about the axis 506, as generally indicated by example arrow 508. In this manner, the direction of air blown by the fan 404 can be angled up or down at any desired angle. In this example, the fan 404 is coupled to the arm 406 without the use of a mounting plate. However, in other examples, the fan 404 can mount to the arm 406 via the mounting plate 408.

FIG. 6 illustrates another example mounting assembly 600 constructed in accordance with teachings of this disclosure. The example mounting assembly 600 of FIG. 6 is similar to the example mounting assembly 500 of FIG. 5, except that the arm 406 in FIG. 6 includes additional example slots 602 distinct and spaced apart from the slots 414. In the example of FIG. 6, the slots 414, 602 are parallel to each other and extend along a longitudinal direction (e.g., longitudinal axis) of the arm 406, as generally indicated by example arrow 604. Additionally or alternatively, the example slots 414, 602 are offset relative to one another in a direction transverse to the longitudinal direction of the arm 406. FIG. 6 shows an example mounting plate 606 that includes example slots 608 that extend along a circular path. In this example, the circular path defined by the slots 608 has a diameter that is larger than a distance between the slots 414, 602 such that the slots 608 in the mounting plate 606 can overlap or align with both of the slots 414, 602 in the arm 406 to facilitate attachment (e.g., a point of attachment) thereto. The circular arrangement of the slots 608 enable the example mounting plate 606 to rotate about an example axis 610, as generally indicated by example arrow 612. Accordingly, the rotatable mounting plate 606 can enable positioning of an example fan (attached to the mounting plate 606) at selectively different rotational positions about the axis 610. In the illustrated example, the mounting plate 606 includes three slots 608. However, in other examples, fewer or more slots 608 may be employed. Additionally or alternatively, the example arm 406 is rotatably coupled to the joint plates 410, 412 via the pivot joints 502, 504. Thus, the arm 406 is rotatable (relative to the joint plates 410, 412) about the axis 506 in a direction generally indicated by the arrow 508. In the example of FIG. 6, the axis 506 is substantially parallel (e.g., exactly parallel, parallel within 5 degrees, etc.) to the longitudinal direction of the arm 406, as generally indicated by the arrow 604.

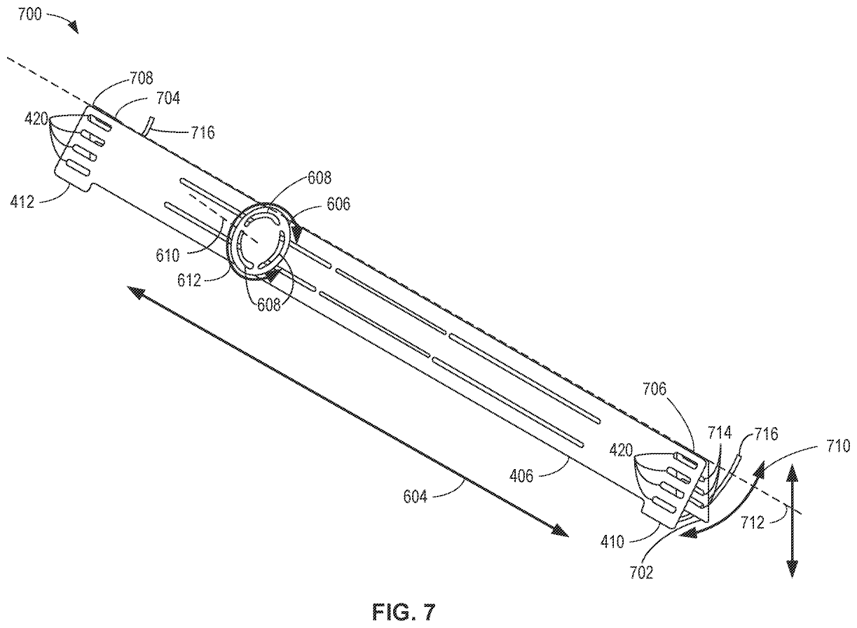

FIG. 7 illustrates another example mounting assembly 700 that is similar to the example mounting assembly 400 of FIG. 4 and the example mounting assembly 600 of FIG. 6. However, the example mounting assembly 700 of FIG. 7 includes additional example joint plates 702, 704 (e.g., mounting plates) that are pivotally coupled to the arm 406 via example hinges 706, 708 (e.g., hinge joints). As such, the angular position of both the arm 406 and the joint plates 410, 412 are adjustable relative to the additional joint plates 702, 704 in a direction generally indicated by example arrow 710. In the example of FIG. 7, the arm 406 is positioned at a first angular position with respect to the additional joint plates 702, 704. However, the arm 406 can be positioned at any angular position (e.g., a second angular position) about an example axis 712. For example, in a first example angular position of the arm 406, the joint plates 702, 704 can be substantially parallel to the joint plates 410, 412. As such, the holes 420 can align with example holes 714 in the joint plates 702, 704 in the first example angular position. However, in a second example angular position of the arm 406, the joint plates 702, 704 can be angled relative to the joint plates 410, 412. In FIG. 7, the example axis 712 extends along a longitudinal axis of the arm 406 (e.g., in a direction generally indicated by the arrow 604) and aligns with a pivot axis of the hinges 706, 708. In some examples, the mounting assembly 700 can include a locking mechanism for securing (e.g., fastening, coupling, etc.) the desired angular position of the arm 406. More particularly, in some examples, example curved braces 716 are attached (e.g., affixed) to the joint plates 410, 412 and constructed to interface (e.g., engage, connect, etc.) with the additional joint plates 702, 704 in a locking manner. The example curved braces 716 can secure the arm 406 in different positions (e.g., points) relative to the joint plates 410, 412 extending from the arm 406 and the additional joint plates 702, 704 coupled thereto by the hinges 706, 708. In other words, the example curved braces 716 may be detachably coupled to the additional joint plates 702, 704 to enable rotation of the arm 406 to different positions or rotation (e.g., angular positions) about the axis 712. In the illustrated example, two curved braces 716 are shown. However, in other examples, fewer (e.g., 1) or more (e.g., 3 or more) curved braces 716 may be employed. In some examples, the curved braces 716 are omitted. In this example, there is no separate arm extending between the two additional joint plates 702, 704. However, in other examples, a separate arm, similar to the arm 406, can extend between the additional joint plates 702, 704. In such examples, one or more hinges may connect the two arms in addition to or instead of the hinges 706, 708 coupling the two sets of joint plates 410, 412, 702, 704. In some examples, the joint plates 410, 412 are couplable to an external frame (e.g., the frame 402 of FIG. 4).

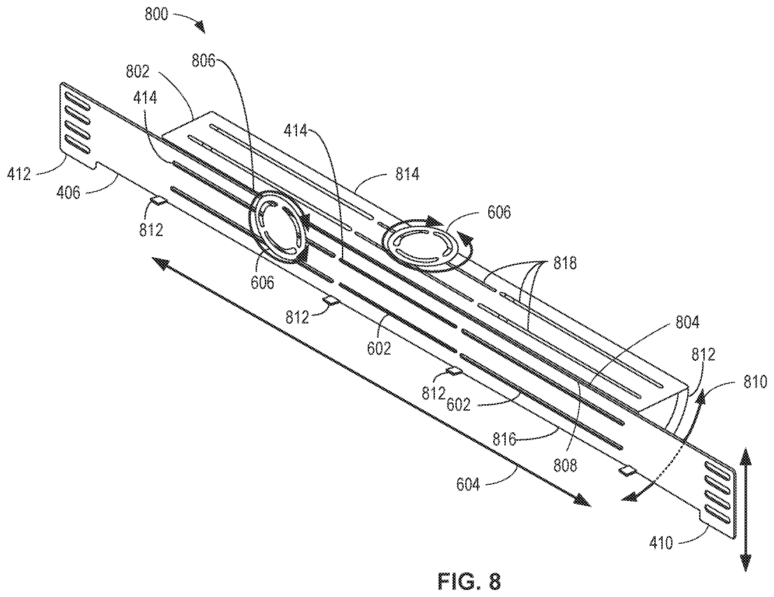

FIG. 8 illustrates another example mounting assembly 800 that is similar to the example mounting assembly 700 of FIG. 7. However, in FIG. 8, the mounting assembly 800 includes a second example arm 802 and an example hinge (e.g., hinge joint) 804. In the example of FIG. 8, the second arm 802 extends along a longitudinal direction of the arm 406 (e.g., generally indicated by the arrow 604) and is pivotally coupled to the arm 406 via the hinge 804. In particular, a first example edge 806 of the arm 802 is coupled to a second example edge 808 of the arm 406. In this example, the hinge 804 is positioned at an interface between the first edge 806 of the arm 802 and the second edge 808 of the arm 406. As such, the example arm 802 can be positioned at any angular location encircling the hinge 804 in a direction generally indicated by example arrow 810. In some examples, the two arms 406, 802 are coupled via more than one hinge 804.

In the example of FIG. 8, example curved braces 812 are attached (e.g., affixed) to the arm 802 and constructed to interface or engage with the arm 406 in a locking manner to secure the arm 802 in different positions (e.g., different angles) relative to the arm 406. In this example, the curved braces 812 connect a third example edge 814 of the arm 802 and a fourth example edge 816 of the arm 406, the third edge 814 opposes the first edge 806 and the fourth edge 816 opposes the second edge 808. Further, at least one of the curved braces 812 is positioned between the joint plates 410, 412. In the illustrated example, four curved braces 812 are shown. However, in other examples, fewer (e.g., 1, 2 or 3) or more (e.g., 4 or more) curved braces 812 may be employed. In some examples, the curved braces 812 are omitted.

In the illustrated example, the second arm 802 includes additional example slots 818 similar to the slots 414, 602 discussed above in connection with FIGS. 4-6. Thus, as shown in FIG. 2, example mounting plates 606 can be attached to both of the arms 406, 802 to facilitate the attachment of multiple fans (fan assemblies) at different orientations. For instance, the example mounting assembly 800 can support a first fan at a first rotational position on the arm 406, with the arm 406 and/or the first fan at a first angular position about the hinge 804. Further, the example mounting assembly 800 can include a second fan at a second rotational position on the arm 802, with the arm 802 and/or the second fan positioned at a second angular position about the hinge 804. In some such examples, the first rotational position of the first fan is different from the second rotational position of the second fan. Further, in some such examples, the first angular position of the arm 406 is different from the second angular position of the arm 802. Further, in some examples, the first and second fans can be placed at different longitudinal positions along the length of the mounting assembly 800. In some examples, at least one of the arms 406, 802 can support at least two mounting plates to support at least two fans. In some examples, the joint plates 410, 412 can be detachably coupled to an edge of at least one of the structures 100, 300 to maintain a vertical positioning of the arm 406. However, the arm 406 can also be adjustable at any rotational position about the hinge 804. In some examples, the arms 406, 802 are adjacent to one another based on either the relative position of the arm 406 and/or the relative position of the arm 802. In such examples, the elongate slots 818 align with the slots 414, 602.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, methods, apparatus, and articles of manufacture have been disclosed that enable adjustable mounting assemblies. Disclosed examples enable efficient air flow, temperature control, and oxygen supply to plants in grow facilities. Examples disclosed herein improve the design and adaptability of fan assemblies.

Example 1 includes an apparatus comprising an arm to extend along a longitudinal axis between a first end and a second end, the arm including an elongate slot to enable attachment of a fan to the arm at selectively different positions along the longitudinal axis, a first joint plate coupled to the first end of the arm, and a second joint plate coupled to the second end of the arm, the first and second joint plates structured to enable attachment to an external support structure.

Example 2 includes the apparatus of example 1, wherein the arm is pivotably coupled to the first and second joint plates about an axis of rotation.

Example 3 includes the apparatus of example 2, wherein the axis of rotation is substantially parallel to the longitudinal axis of the arm.

Example 4 includes the apparatus of example 1, further including third and fourth joint plates pivotably coupled to the first and second joint plates, the third and fourth joint plates to rotate relative to the first and second joint plates between a first position and a second position, the third and fourth joint plates to be substantially parallel to the first and second joint plates when in the first position, the third and fourth joint plates to be angled relative to the first and second joint plates when in the second position.

Example 5 includes the apparatus of example 4, wherein the first and second joint plates include respective first and second holes, the first and second holes align with respective third and fourth holes in respective ones of the third and fourth joint plates when the third and fourth joint plates are in the first position.

Example 6 includes the apparatus of example 4, further including a brace affixed to one of the first or the third joint plates, the brace to engage with at least one of the first or the third joint plates to secure the arm in different positions relative to the third joint plate.

Example 7 includes the apparatus of example 1, wherein the arm is a first arm, further including a second arm pivotably coupled to the first arm, the second arm to extend along the longitudinal axis.

Example 8 includes the apparatus of example 7, further including a brace affixed to one of the first arm or the second arm, the brace to engage with at least one of the first arm or the second arm to secure the second arm in different positions relative to the first arm.

Example 9 includes the apparatus of example 1, wherein the elongate slot is a first elongate slot, the arm including a second elongate slot substantially parallel to the first elongate slot, the first and second elongate slots offset relative to one another in a direction transverse to the longitudinal axis.

Example 10 includes the apparatus of example 1, further including a mounting plate to facilitate attachment of the fan to the arm, the mounting plate rotatably couplable to the arm about an axis of rotation to enable positioning of the fan at selectively different positions about the axis of rotation.

Example 11 includes an apparatus comprising an elongate body including a first slot proximate a first end of the elongate body, a second slot proximate a second end of the elongate body, and a third slot extending along a longitudinal axis of the elongate body between the first and second slots, and a mounting plate couplable to the elongate body via the third slot, the mounting plate to support a fan at different positions along the elongate body based on a point of attachment of the mounting plate along a length of the third slot.

Example 12 includes the apparatus of example 11, wherein the first end and the second end are couplable to an external frame via the first and second slots.

Example 13 includes the apparatus of example 11, wherein the elongate body is a first elongate body, further including a second elongate body coupled to an edge of the first elongate body.

Example 14 includes the apparatus of example 13, further including a hinge joint to pivotably couple the first elongate body to the second elongate body, the hinge joint positioned along the edge.

Example 15 includes the apparatus of example 11, wherein the mounting plate is a first mounting plate, wherein the elongate body includes a second mounting plate positioned at the first end of the elongate body and a third mounting plate positioned at the second end of the elongate body, the second mounting plate including the first slot, the third mounting plate including the second slot.

Example 16 includes the apparatus of example 15, further including a first joint to connect the second mounting plate to a central arm of the elongate body, and a second joint to connect the third mounting plate to the central arm of the elongate body, the first and second joints to enable rotation of the central arm relative to the second and third mounting plates along the longitudinal axis.

Example 17 includes the apparatus of example 15, further including first and second hinge joints, the first hinge joint to pivotably couple the second mounting plate and a fourth mounting plate, the second hinge joint to pivotably couple the third mounting plate and a fifth mounting plate.

Example 18 includes the apparatus of example 17, wherein the fourth and fifth mounting plates are couplable to an external frame.

Example 19 includes the apparatus of example 17, further including a brace extending from the second mounting plate, the fourth mounting plate detachably couplable to different points along a length of the brace associated with different angular positions of the fourth mounting plate relative to the second mounting plate.

Example 20 includes an apparatus comprising an arm detachably couplable to a fan assembly, the fan assembly movable along a longitudinal axis of the arm, and joint plates connected to the arm, the joint plates detachably couplable to an external frame.

Example 21 includes the apparatus of example 20, the arm is a first arm, further including a second arm pivotably coupled to the first arm via a hinge, the hinge positioned at an interface between a first edge of the first arm and a second edge of the second arm.

Example 22 includes the apparatus of example 21, wherein the fan assembly is a first fan assembly, further including a second fan assembly detachably coupled to the second arm, the second fan assembly movable along a longitudinal axis of the second arm.

Example 23 includes the apparatus of example 21, wherein the first arm includes a third edge opposite the first edge, and the second arm includes a fourth edge opposite the second edge, further including a curved brace to connect the third edge of the first arm and the fourth edge of the second arm.

Example 24 includes the apparatus of example 23, wherein the curved brace is to connect at least one of the joint plates of the first arm to a joint plate of the second arm.

Example 25 includes the apparatus of example 23, wherein the curved brace is connected to the second edge of the first arm at a location spaced apart from and between the joint plates.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
an arm to extend along a longitudinal axis between a first end and a second end, the arm including an elongate slot to enable attachment of a fan to the arm at selectively different positions along the longitudinal axis;
a first joint plate coupled to the first end of the arm; and
a second joint plate coupled to the second end of the arm, the first and second joint plates structured to enable attachment to an external support structure.

2. The apparatus of claim 1, wherein the arm is pivotably coupled to the first and second joint plates about an axis of rotation.

3. The apparatus of claim 2, wherein the axis of rotation is substantially parallel to the longitudinal axis of the arm.

4. The apparatus of claim 1, further including third and fourth joint plates pivotably coupled to the first and second joint plates, the third and fourth joint plates to rotate relative to the first and second joint plates between a first position and a second position, the third and fourth joint plates to be substantially parallel to the first and second joint plates when in the first position, the third and fourth joint plates to be angled relative to the first and second joint plates when in the second position.

5. The apparatus of claim 4, wherein the first and second joint plates include respective first and second holes, the first and second holes align with respective third and fourth holes in respective ones of the third and fourth joint plates when the third and fourth joint plates are in the first position.

6. The apparatus of claim 4, further including a brace affixed to one of the first or the third joint plates, the brace to engage with at least one of the first or the third joint plates to secure the arm in different positions relative to the third joint plate.

7. The apparatus of claim 1, wherein the arm is a first arm, further including a second arm pivotably coupled to the first arm, the second arm to extend along the longitudinal axis.

8. The apparatus of claim 7, further including a brace affixed to one of the first arm or the second arm, the brace to engage with at least one of the first arm or the second arm to secure the second arm in different positions relative to the first arm.

9. (canceled)

10. The apparatus of claim 1, further including a mounting plate to facilitate attachment of the fan to the arm, the mounting plate rotatably couplable to the arm about an axis of rotation to enable positioning of the fan at selectively different positions about the axis of rotation.

11. An apparatus comprising:
an elongate body including a first slot proximate a first end of the elongate body, a second slot proximate a second end of the elongate body, and a third slot extending along a longitudinal axis of the elongate body between the first and second slots; and
a mounting plate couplable to the elongate body via the third slot, the mounting plate to support a fan at different positions along the elongate body based on a point of attachment of the mounting plate along a length of the third slot.

12. (canceled)

13. The apparatus of claim 11, wherein the elongate body is a first elongate body, further including a second elongate body coupled to an edge of the first elongate body.

14. The apparatus of claim 13, further including a hinge joint to pivotably couple the first elongate body to the second elongate body, the hinge joint positioned along the edge.

15. The apparatus of claim 11, wherein the mounting plate is a first mounting plate, wherein the elongate body includes a second mounting plate positioned at the first end of the elongate body and a third mounting plate positioned at the second end of the elongate body, the second mounting plate including the first slot, the third mounting plate including the second slot.

16. The apparatus of claim 15, further including:
a first joint to connect the second mounting plate to a central arm of the elongate body; and
a second joint to connect the third mounting plate to the central arm of the elongate body, the first and second joints to enable rotation of the central arm relative to the second and third mounting plates along the longitudinal axis.

17. (canceled)

18. (canceled)

19. The apparatus of claim 17, further including a brace extending from the second mounting plate, the fourth mounting plate detachably couplable to different points along a length of the brace associated with different angular positions of the fourth mounting plate relative to the second mounting plate.

20. An apparatus comprising:
an arm detachably couplable to a fan assembly, the fan assembly movable along a longitudinal axis of the arm; and
joint plates connected to the arm, the joint plates detachably couplable to an external frame.

21. The apparatus of claim 20, the arm is a first arm, further including a second arm pivotably coupled to the first arm via a hinge, the hinge positioned at an interface between a first edge of the first arm and a second edge of the second arm.

22. (canceled)

23. The apparatus of claim 21, wherein the first arm includes a third edge opposite the first edge, and the second arm includes a fourth edge opposite the second edge, further including a curved brace to connect the third edge of the first arm and the fourth edge of the second arm.

24. The apparatus of claim 23, wherein the curved brace is to connect at least one of the joint plates of the first arm to a joint plate of the second arm.

25. The apparatus of claim 23, wherein the curved brace is connected to the second edge of the first arm at a location spaced apart from and between the joint plates.
